(19) United States
(12) Patent Application Publication
(10) Pub. No.: US 2026/0244022 A1
(43) Pub. Date: Aug. 20, 2026

(54) DISPLAY DEVICE

(71) Applicant: Japan Display Inc., Tokyo (JP)

(72) Inventors: Shinichi KOMURA, Tokyo (JP); Jin HIROSAWA, Tokyo (JP); Koichi OKUDA, Tokyo (JP)

(73) Assignee: Japan Display Inc., Tokyo (JP)

(21) Appl. No.: 19/542,666

(22) Filed: Feb. 18, 2026

(30) Foreign Application Priority Data
Feb. 18, 2025 (JP) 2025-024043

(51) Int. Cl. G02B 27/01

(52) U.S. Cl. CPC G02B 27/0172

(57) ABSTRACT

According to an embodiment, in a display device, a third edge and a fourth edge a first light guide are each provided between the first edge and the second edge. A seventh edge and an eighth edge of a second light guide are each provided between the fifth edge and the sixth edge. The second edge and the sixth edge overlap and coincide with each other. The first light guide and the second light guide are disposed obliquely such that a direction of a main ray emitted from the light source element and propagating through the first light guide forms an acute angle with a direction of a main ray propagating through the second light guide.

### CROSS-REFERENCE TO RELATED APPLICATIONS

This application is based upon and claims the benefit of priority from Japanese Patent Application No. 2025-024043, filed Feb. 18, 2025, the entire contents of which are incorporated herein by reference.

### FIELD

Embodiments described herein relate generally to a display device.

### BACKGROUND

Head-mounted displays with a display panel having such a shape that a part of which is cut out have been developed. Further, laser backlights with a laser light source have also been developed.

### BRIEF DESCRIPTION OF THE DRAWINGS

FIG. 1 is a perspective view showing an example of the external appearance of a display device according to Embodiment 1.

FIG. 2 is a perspective view schematically showing a configuration of the display device according to Embodiment 1.

FIG. 3 is a plan view schematically showing the configuration of the display device of Embodiment 1.

FIG. 4 is a plan view schematically showing an example of the configuration of the display device.

FIG. 5 is a cross-sectional view taken along the line A1-A2 of the display device shown in FIG. 3.

FIG. 6 is a cross-sectional view schematically showing another example of a configuration of the display device.

FIG. 7 is a plan view of the display device shown in FIG. 3 when unfolded.

FIG. 8 is a plan view schematically showing an example of a configuration of a display device of Embodiment 2.

FIG. 9 is a plan view showing only a light guide LGMh of FIG. 8.

FIG. 10 is a plan view of the display device of FIG. 8 when unfolded.

### DETAILED DESCRIPTION

In general, according to one embodiment, a display device comprises
a first light guide including a first edge, a second edge, a third edge, and a fourth edge;
a second light guide including a fifth edge, a sixth edge, a seventh edge, and an eighth edge;
a plurality of light source elements disposed to face the first edge of the first light guide; and
a display panel provided adjacent to the first light guide or the second light guide,
wherein
the second edge is disposed on a side opposite to the first edge and is non-parallel to the first edge,
the third edge and the fourth edge are each provided between the first edge and the second edge,
the sixth edge is disposed on a side opposite to the fifth edge and is non-parallel to the fifth edge,
the seventh edge and the eighth edge are each provided between the fifth edge and the sixth edge,
the second edge and the sixth edge overlap, and
the first light guide and the second light guide are disposed obliquely such that a direction of a main ray emitted from the light source element and propagating through the first light guide forms an acute angle with a direction of a main ray propagating through the second light guide.

Further, according to another embodiment, a display device includes
a first light guide including a first edge, a second edge, a third edge, and a fourth edge;
a second light guide including a fifth edge, a sixth edge, a seventh edge, and an eighth edge;
a plurality of light source elements disposed to face the first edge of the first light guide;
a display panel provided adjacent to the first light guide or the second light guide,
wherein
the first edge includes a plurality of first short edges and a plurality of second short edges arranged in a step-like configuration,
the plurality of light source elements are disposed to face the plurality of first short edges, respectively,
the second edge is disposed on a side opposite to the first edge and is non-parallel to the first edge,
the third edge and the fourth edge are each provided between the first edge and the second edge,
the sixth edge is disposed on a side opposite to the fifth edge and is non-parallel to the fifth edge,
the seventh edge and the eighth edge are each provided between the fifth edge and the sixth edge,
the second edge and the sixth edge overlap and coincide with each other, and
the first light guide and the second light guide are disposed obliquely such that a direction of a main ray emitted from the light source element and propagating in the first light guide forms an acute angle with a direction of a main ray propagating through the second light guide.

One objective of this embodiment is to provide a display device for a head-mounted display that does not hit the user's nose.

Another objective of this embodiment is to provide an illumination device which can emit light having uniform brightness and a display device which can display images having uniform brightness.

Embodiments will be described hereinafter with reference to the accompanying drawings. Note that the disclosure is merely an example, and proper changes within the spirit of the invention, which are easily conceivable by a skilled person, are included in the scope of the invention as a matter of course. In addition, in some cases, in order to make the description clearer, the widths, thicknesses, shapes, etc., of the respective parts are schematically illustrated in the drawings, compared to the actual modes. However, the schematic illustration is merely an example, and adds no restrictions to the interpretation of the invention. Besides, in the specification and drawings, the same or similar elements as or to those described in connection with preceding drawings or those exhibiting similar functions are denoted by like reference numerals, and a detailed description thereof is omitted unless otherwise necessary.

The embodiments described herein are not general ones, but rather embodiments that illustrate the same or corresponding special technical features of the invention. The following is a detailed description of one embodiment of a display device with reference to the drawings.

In this embodiment, a first direction X, a second direction Y and a third direction Z are orthogonal to each other, but may intersect at an angle other than 90 degrees. The direction toward the tip of the arrow in the third direction Z is defined as up or above, and the direction opposite to the direction toward the tip of the arrow in the third direction Z is defined as down or below. Note that the first direction X, the second direction Y and the third direction Z may as well be referred to as an X direction, a Y direction and a Z direction, respectively.

With such expressions as “the second member above the first member” and “the second member below the first member”, the second member may be in contact with the first member or may be located away from the first member. In the latter case, a third member may be interposed between the first member and the second member. On the other hand, with such expressions as “the second member on the first member” and “the second member beneath the first member”, the second member is in contact with the first member.

Further, it is assumed that there is an observation position to observe the optical control element on a tip side of the arrow in the third direction Z. Here, viewing from this observation position toward the X-Y plane defined by the first direction X and the second direction Y is referred to as plan view. Viewing a cross-section of the display device in the X-Z plane defined by the first direction X and the third direction Z or in the Y-Z plane defined by the second direction Y and the third direction Z is referred to as cross-sectional view.

### Embodiment 1

FIG. 1 is a perspective view showing an example of the appearance of the display device according to Embodiment 1. In Embodiment 1, the display device includes a head mounted display (HMD) that is mounted on the head of the user USR when used. Such a display device is used to provide, for example, virtual reality (VR) to the user USR wearing the display device on his/her head.

As shown in FIG. 1, the display device HMD comprises a display panel PNLh for a left eye and a display panel PNLm for a right eye. Note that the display panel PNLh and the display panel PNLm may as well be referred to as the first display panel and the second display panel, respectively. The display panel PNLh and the display panel PNLm are display panels independent from each other.

The display panel PNLh and display panel PNLm are respectively arranged so that they are positioned in front of the left and right eyes of the user USR when the user USR wears the display device HMD on his/her head. In this embodiment, it is assumed that the display panel PNLh and the display panel PNLm are liquid crystal display panels with a liquid crystal layer.

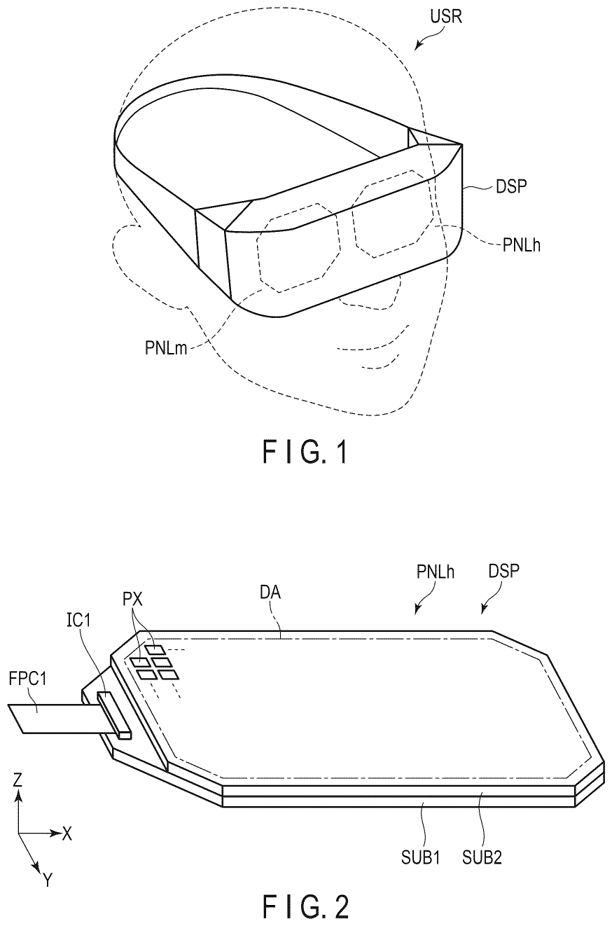

FIG. 2 is a perspective view schematically showing a configuration of the display panel provided in the display device of Embodiment 1. Here, the configuration of the display panel PNLh will be mainly explained.

The display panel PNLh shown in FIG. 2 comprises a substrate SUB1 and a substrate SUB2 facing the substrate SUB1. The display panel PNLh also includes a display area DA that displays images. Further, the display panel PNLh comprises a plurality of pixels PX arranged in a matrix in the display area DA, for example.

In addition, the display panel PNLh comprises a drive IC chip IC1 that drives the display panel PNLh and a flexible printed circuit board FPC1 that transmits control signals to the display panel PNLh. The flexible printed circuit board FPC1 is connected to a control module (host computer) that controls the operation of the display device DSP.

In the example shown in FIG. 2, the substrate SUB1 and the substrate SUB2 each have long sides that run along the first direction X and short sides that run along the second direction Y. The substrate SUB1 and the substrate SUB2 each have an octagonal shape in a plan view. This shape can also be described as a shape in which the corners of a rectangle are cut off. The shape of the display panel PNLh in a plan view is an octagonal shape.

Note that the shapes of the display panel PNLh are not limited to that of this case, but it suffices if they have a polygonal shape. The shape of the display panel may be any shape as long as it can prevent it from hitting the nose of the user, that is, a shape whose corner portion close to the nose of the user USR is cut off.

In the example shown in FIG. 2, the shape of the display panel PNLh is described. The display panel PNLm has a shape that is line-symmetrical with respect to the second direction Y relative to the display panel PNLh. Note that the configuration of the display panel PNLm is similar to that of the display panel PNLh except for the point that it has a shape that is line-symmetrical with respect to the second direction Y.

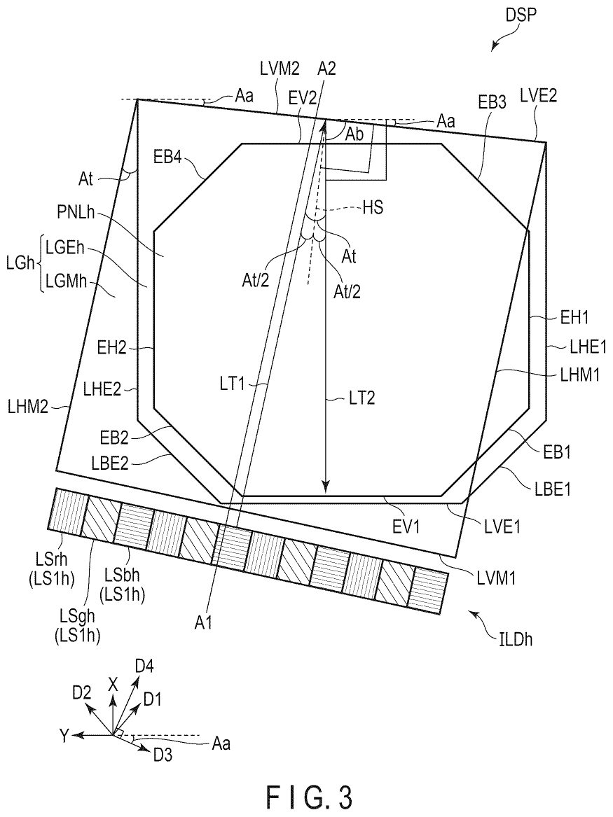

FIG. 3 is a plan view schematically showing an example of the configuration of the display device of Embodiment 1. FIG. 3 shows the left-eye display panel PNLh and illumination device ILDh.

The display panel PNLh is a polygonal display panel, for example, an octagonal display panel. The display panel PNLh has edges EH1 and EH2 extending in a direction parallel to the first direction X, and edges EV1 and EV2 extending in a direction parallel to the second direction Y.

The display panel PNLh has an edge EB1 provided between the edges EH1 and EV1 and extending in a direction forming an acute angle counterclockwise relative to the first direction X. The display panel PNLh has an edge EB2 provided between the edges EH2 and EV1 and extending in a direction forming an acute angle clockwise relative to the first direction X.

The direction in which the edge EB1 extends, that is, the direction forming an acute angle counterclockwise relative to the first direction X, is also referred to as a direction D1. The direction in which the edge EB2 extends, that is, the direction forming an acute angle clockwise relative to the first direction X, is also referred to as a direction D2.

The directions D1 and D2 are also referred to as the fourth direction and the fifth direction, respectively. But note that, when the third direction Z is omitted, the direction D1 and the direction D2 are also referred to as the third direction and fourth direction, respectively.

The display panel PNLh has an edge EB3 provided between the edges EH1 and EV2 and extending in the direction D2. The display panel PNLh has an edge EB4 provided between the edges EH2 and EV2 and extending in the direction D1.

The illumination device ILDh has a light guide LGMh and a light guide LGEh. The light guide LGMh is a light-mixing light guide. The light guide LGEh is a light-emitting light guide. The light guides LGMh and LGEh are collectively referred to as a light guide LGh.

The light guide LGEh is disposed approximately parallel to the display panel PNLh. The light guide LGMh is arranged obliquely at an angle relative to the light guide LGEh.

The light guide LGEh has edges LHE1 and LHE2 extending in a direction parallel to the first direction X, and an edge LVE1 extending in a direction parallel to the second direction Y. The light guide LGEh has an edge LBE1 extending along the direction D1 and an edge LBE2 extending along the direction D2. The edge LBE1 is provided between the edge LHE1 and the edge LVE1. The edge LBE2 is provided between the edge LHE2 and the edge LVE1. The edges LHE1 and LHE2 need not necessarily be parallel to each other. Further, the edge LVE1 need not necessarily be parallel to the second direction Y and may be inclined relative to the second direction Y.

The edges LHE1 and LHE2 of the light guide LGEh are respectively disposed near the edges EH1 and EH2 of the display panel PNLh. The edge LVE1 of the light guide LGEh is disposed near the edge EV1 of the display panel PNLh. The edges LBE1 and LBE2 of the light guide LGEh are respectively disposed near the edges EB1 and EB2 of the display panel PNLh.

The angle formed between the direction in which the edge LVE2 extends and the direction perpendicular to the direction in which light LT2 extends is defined as an angle Aa. In FIG. 3, the edge LVE2 of the light guide LGEh extends in a direction having an acute angle Aa clockwise relative to the second direction Y. The direction in which the edge LVE2 extends, in other words, the direction having an angle Aa clockwise relative to the second direction Y, is defined as a direction D3. The edge LVE2 extends non-parallel to the edge LVE1. When the edge LVE1 is inclined from the second direction Y, the edge LVE2 extends in a direction forming an acute angle Aa clockwise from the edge LVE1.

The light guide LGMh has edges LVM1 and LVM2 extending in a direction parallel to the direction D3. The light guide LGMh has edges LHM1 and LHM2 extending along a direction D4, which is perpendicular to the direction D3. Note here that the edges LVM1 and LVM2 need not necessarily be parallel to each other. The edges LHM1 and LHM2 need not necessarily be parallel to each other.

The directions D3 and D4 are also referred to as a sixth direction and a seventh direction, respectively. Note here that when the direction Z is omitted, the directions D3 and D4? are also referred to as the fifth direction and the sixth direction, respectively.

The edge LVM2 of the light guide LGMh and the edge LVE2 of the light guide LGEh overlap and coincide with each other. The edge LVM2 and edge LVE2 extend to overlap each other along the direction D3.

As described above, the light guide LGMh is disposed obliquely relative to the light guide LGEh. In FIG. 3, the angle between the edge LHM2 of the light guide LGMh and the edge LHE2 of the light guide LGEh is an angle At, which will be described later. Although not shown in the figures, the angle between the edge LHE1 and the edge LHM1 as well is an angle At.

A plurality of light source elements LS1h are provided along the edge LVM1 of the light guide LGMh. These light source elements LS1h include a light source element LSrh that emits red light, a light source element LSgh that emits green light, and a light source element LSbh that emits blue light. The light source element LSrh, the light source element LSgh, and the light source element LSbh are arranged in this order along the direction D3.

For the light source element LS1h, a laser light source (laser diode) such as a semiconductor laser that emits laser light, may be used. This laser light may be diffused light having a spread centered on the irradiation direction, or it may be polarized laser light.

With reference to FIG. 3, the optical path of light emitted from the light source element LS1h propagating within the light guide LGh will be described. As shown in FIG. 3, light LT1 emitted from the light source element LS1h enters the inside of the light guide LGMh from the edge LVM1 thereof.

The light LT1 having entered the inside of the light guide LGMh propagates along the direction D4 while undergoing repeated total internal reflection within the light guide LGMh. The direction D4 is the direction in which the edges LHM1 and LHM2 extend.

As will be described in detail later, the light LT1 reaching the edge LVM2 of the light guide LGMh enters the inside of the light guide LGEh from the edge LVE2 of the light guide LGEh. The light LT1 having entered the inside of the light guide LGEh propagates in a direction opposite to the first direction X as light LT2, while undergoing repeated total internal reflection within the inside of the light guide LGEh.

Note that in the embodiment, the light LT1 refers to light emitted from the light source element LS1h and having a predetermined light distribution angle. The light LT2 refers to light that enters the light guide LGEh and propagates therewithin, and has the predetermined light distribution angle. Further, the light LT1 and the light LT2 may each refer to the main rays of light having the predetermined light distribution angle.

The light LT2 having reached a protrusion not illustrated (which may as well be referred to as a prism or groove) provided on the light guide LGEh no longer satisfies the condition for the total internal reflection. The light LT2 that does not satisfy the total internal reflection condition is emitted from the light guide LGEh and enters the display panel PNLh. In this manner, the display panel PNLh is illuminated.

In the embodiment, the angle formed by the direction of the main rays of the light LT1 propagating through the light guide LGMh and the direction of the main rays of the light LT2 propagating through the light guide LGEh is an angle At. In FIG. 3, it is designed such that the light LT1 emitted from the light source element LS1h to the edge LVM1 of the light guide LGMh, when reflected at the edge LVM2, becomes parallel to the edges LHE1 and LHE2 of the light guide LGEh.

In the embodiment, the light guide LGMh and light guide LGEh are disposed such that the angle formed by the direction of the main ray of the light LT1 and the direction of the main ray of the light LT2 is an angle At. In this case, note that the respective opposing edges of the light guides LGMh and LGEh need not necessarily be parallel to each other.

As described above, the angle Aa is the angle formed by the edge LVE2 of the light guide LGEh and the second direction Y. The angle formed by the edge LVE2 and the first direction X (the direction in which the edges LHE1 and LHE2 extend) is defined as an angle Ab.

The normal line to the edges LVE2 and LVM2 is defined as a normal HS. The angle formed between the second direction Y and the first direction X is 90°. The angle formed between the normal HS and the edge LVM2 is also 90°. The angles formed between the normal HS and the light LT1, and between the normal HS and the light LT2, are both At/2.

From FIG. 3, (Formula 1) holds.

(At/2)+Ab=Aa+Ab=90° (Formula 1)

From (Formula 1), (Formula 2) holds.

Aa=At/2 (Formula 2)

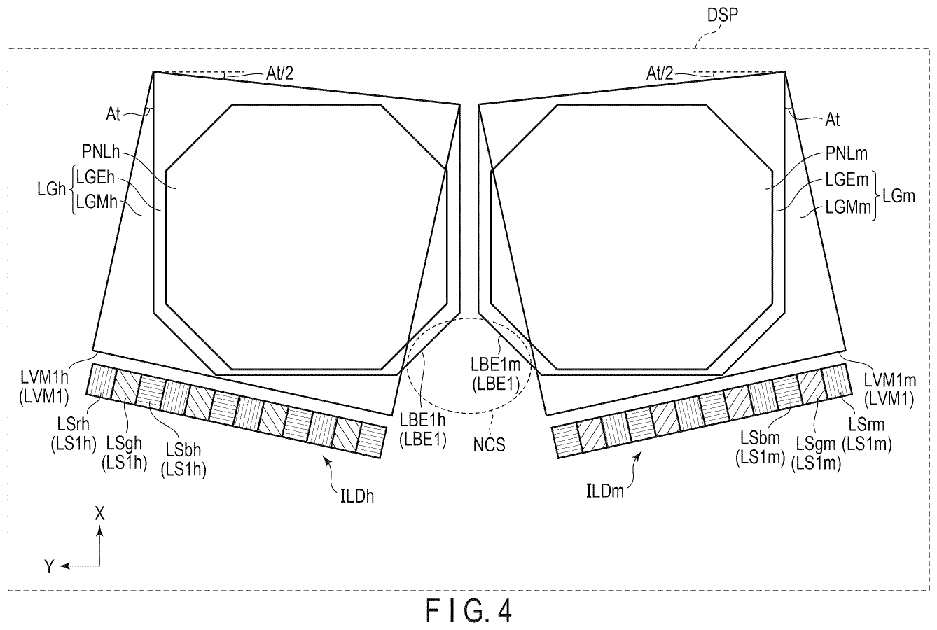

FIG. 4 is a plan view schematically showing an example of the configuration of the display device. The display device DSP shown in FIG. 4 includes a display panel PNLh and an illumination device ILDh for the left eye, and a display panel PNLm and an illumination device ILDm for the right eye. The illumination device ILDm and the display panel PNLm are arranged in line symmetry with respect to the first direction X.

The edges LVM1 and LBE1 shown in FIG. 3 correspond to edges LVM1h and LBE1h in FIG. 4, respectively.

The illumination device ILDm includes a light-emitting light guide LGEm and a light-mixing light guide LGMm. The light guide LGMm and the light guide LGEm are collectively referred to as a light guide LGm. The illumination device ILDm includes edges LVM1m and LBE1m that are line-symmetrical with respect to the edges LVM1h and LBE1h, respectively, in relation to the first direction X as the axis.

For clarity in the drawings, not all reference numerals are shown, but note that the illumination device ILDm and the display panel PNLm each have edges that are line-symmetrical with respect to the display panel PNLh and illumination device ILDh for the left eye.

Along the direction in which the edge LVM1m extends, a plurality of light source elements LS1m are provided. These light source elements LS1m include a light source element LSrm that emits red light, a light source element LSgm that emits green light, and a light source element LSbm that emits blue light. The light source element LSrm, the light source element LSgm, and the light source element LSbm are arranged in this order along the direction in which the edge LVM1m extends.

A space NCS is provided between the display panel PNLh and the illumination device ILDh, and between the illumination device ILDm and the display panel PNLm, more specifically, between the edge LBE1h and the edge LBE1m. In the display device DSP shown in FIG. 4, a sufficient space NCS can be provided for the user's nose.

How the light LT1 having reached the edge LVM2 of the light guide LGMh enters the inside of the light guide LGEh from the edge LVE2 of the light guide LGEh will now be described in detail.

FIG. 5 is a cross-sectional view taken along the line A1-A2 of the display device in FIG. 3. The display device DSP shown in FIG. 5 comprises an illumination device ILDh and a display panel PNLh. The display panel PNLh is provided on top of the illumination device ILDh.

The illumination device ILDh comprises a reflector REFh, a light guide LGEh including a light-outputting structure LPR for emitting light LT propagating within the light guide from a surface LUS, which is the upper surface of the emission light guide LGEh, a light guide LGMh, which is a mixing light guide for mixing laser light, an optical sheet OPSh, and a light source element LS1h. The reflector REFh, the light guide LGEh, the mixing light guide LGMh, and the optical sheet OPSh are stacked in this order.

In FIG. 5, among the surfaces of the light guide LGMh, the first surface on the left side of the page, which faces the light source element LS1h is referred to as a surface GVU1h, and the second surface on the right side of the page, which reflects light is referred to as a surface GVU2h. Among the surfaces of the light guide LGEh, the third surface on the left side of the page is referred to as a surface GVL1h, and the fourth surface on the right side of the page, which reflects light is referred to as a surface GVL2h.

Note here that, when viewed in cross-section, the surface GVU1h, which is the first surface, and the second surface GVU2h, which is the second surface, are also referred to as a first edge and a second edge, respectively. Further, when viewed in cross-section, the surface GVL1h, which is the third surface, and the surface GVL2h, which is the fourth surface, are referred to as a third edge and a fourth edge, respectively. The surface GVU2h and the surface GVL2h are inclined obliquely relative to the plane containing the third direction Z.

The light guide LGPEh, which is a light-emitting light guide, has a cross-sectional shape of trapezoid where the lower base is shorter than the upper base. The surface GVL1h, which is the left edge of this trapezoidal shape, extends obliquely relative to the third direction Z. The surface GVL2h, which is the right edge of this trapezoidal shape, extends obliquely relative to the third direction Z.

The bottom surface of the light guide LGPEh is referred to as a surface LBS, and the upper surface is referred to as a surface LUS. The surface LBS faces the reflector plate REFh. The surface LUS faces the light guide LGMh, which is a light-mixing light guide. A plurality of light-outputting structures LPR (hereinafter also referred to as protrusions, projections, grooves, or prisms) are provided on the surface LBS. The light LT reflected by these light-outputting structures LPR is emitted upward. The thickness of the light guide LGEh (the distance along the third direction Z) is set as a thickness d0.

The light guide LGMh, which is a light-mixing light guide, has a cross-sectional shape of a trapezoid in which the lower base is longer than the upper base. The left edge of this trapezoidal shape, which is the surface GVU1h, extends along the third direction Z. The right edge of this trapezoidal shape, which is the surface GVU2h, extends obliquely relative to the third direction Z. The thickness of the light-mixing light guide LGM is set to a thickness d1. The thickness d1 is less than the thickness d0(d1<d0).

The bottom surface of the light guide LGMh is defined as a surface UBS, and the upper surface is defined as a surface UUS. The surface UBS faces the surface LUS of the light guide LGEh. The surface UUS faces an optical sheet OPSh.

The light guide LGMh, which is a light-mixing light guide, and the light guide LGEh, which is a light-emitting light guide, may be formed from respective transparent materials having the same refractive index. The refractive index of the transparent materials should preferably be close to that of air. Examples of such transparent materials include glass and light-transmitting organic resins. More specifically, the light-transmitting organic resins include acrylic resins.

The light source element LS1h is provided to face the surface GVU1h of the light guide LGMh. The light LT emitted from the light source element LS1h enters the light guide LGMh from the surface GVU1h of the light guide LGMh.

For the light source element LS1h, for example, a laser light source (laser diode) such as a semiconductor laser that emits laser light, may be used. This laser light may be diffused light having a spread centered on the irradiation direction, or it may be polarized laser light.

The surface GVU2h, which is the second edge, and the surface GVL2h, which is the fourth edge, are inclined obliquely relative to the direction D4, as shown in FIG. 5, which is perpendicular to the third direction Z.

The angle of the surface GVL2h with respect to the direction D4 is referred to as an angle Aa. The angle of the surface GVU2h with respect to the direction perpendicular to the third direction Z (direction X in FIG. 5) is referred to as an angle Ab.

On the main surfaces of the reflector REFh and the optical sheet OPSh, a plurality of protrusions (which may as well be referred to as prisms) are provided. The optical sheet OPSh includes, for example, a prism sheet or a diffuser plate.

As described above, the light LT emitted from the light source element LS1h enters the light guide LGMh from the surface GVU1h thereof. The entering light LT propagates from the surface GVU1h to the surface GVU2h. The light LT having reached the surface GVU2h, which satisfies the conditions for total internal reflection, is reflected downward at the surface GVU2h, and enters the light guide LGEh.

The light having entered the light guide LGEh, which satisfies the conditions for total internal reflection at the surface GVL2h, reaches the surface LBS. The light LT repeatedly reflects between the surface LBS and the surface LUS, and propagates along a direction opposite to the first direction X.

When the propagating light LT enters the light-outputting structures LPR provided on the surface LBS, which is the lower surface of the light guide LGEh, the light LT is reflected by the light-outputting structures LPR and is lifted upward. The upwardly lifted light LT exits the light guide LGEh, passes through the light guide LGMh, and enters the optical sheet OPSh. The light LT having entered the optical sheet OPSh is emitted upward along a direction parallel to the third direction Z by the protrusions provided on the optical sheet OPSh. Then, the light LT enters the display panel PNLh from the optical sheet OPSh.

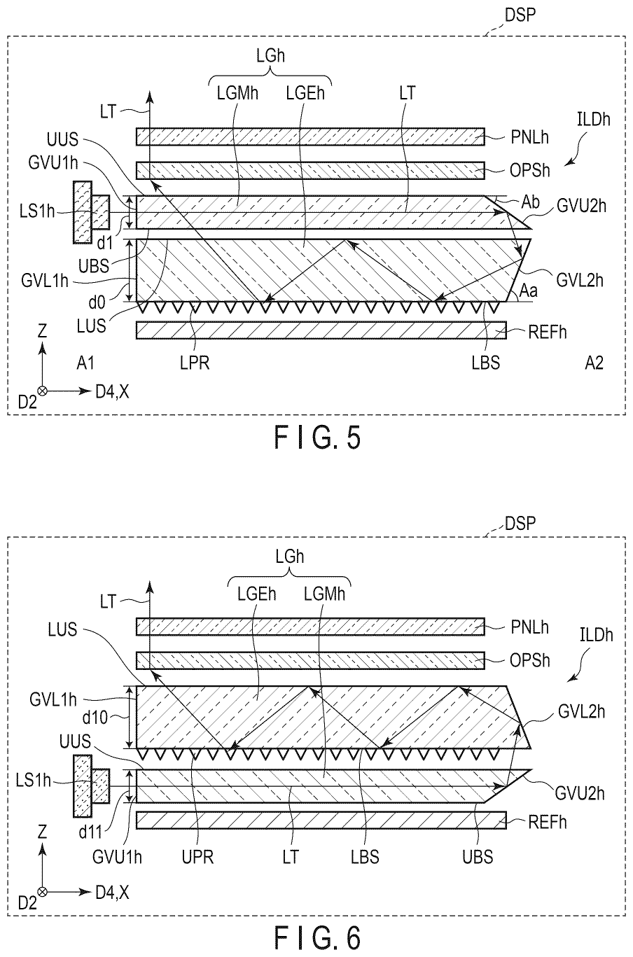

FIG. 6 is a cross-sectional view schematically showing another example of the configuration of the display device. The light guide LGMh, which is a light-mixing light guide shown in FIG. 6, is the light guide LGMh shown in FIG. 5 arranged upside down. The light-emitting light guide LGEh shown in FIG. 6 has a trapezoidal cross-section along the first direction X, in which the length of the bottom surface LBS, which faces the light guide LGMh, along the first direction X is greater than the length of the upper surface LUS along the first direction X. In FIG. 6, the reflector REFh, the light-mixing light guide LGM, the light-emitting light guide LGP, and the optical sheet OPSh are stacked in this order.

For aspects of the illumination device ILDh shown in FIG. 6 that are similar to those of the illumination device ILDh shown in FIG. 5, the descriptions provided with reference to FIG. 5 are incorporated by reference and omitted here. Now, the differences of the illumination device ILDh shown in FIG. 6 as compared to the illumination device ILDh shown in FIG. 5 will be discussed.

A plurality of light-outputting structures UPR are provided on the surface LBS, which is the lower surface of the light-emitting guide plate LGEh. The light reflected by these light-outputting structures UPR is emitted upward.

The thickness of the light-mixing light guide LGMh is referred to as a thickness d11. The thickness of the light guide LGEh is referred to as a thickness d10. Here, the thickness d10 is greater than the thickness d11 (d10>d11).

The light source element LS1h is provided to face the surface GVU1h of the light guide LGMh. The light LT emitted from the light source element LS1h enters the light guide LGMh from the surface GVU1h of the light guide LGMh.

The light LT having entered the light guide LGMh propagates from the surface GVU1h to the surface GVU2h. The light LT having reached the surface GVU2h undergoes total internal reflection at the surface GVU2h, is reflected upward and re-enters the light guide LGMh. The surface GVU2h is inclined such that the light from the light source element satisfies the conditions for total internal reflection.

The light having entered the light-emitting guide plate LGEh undergoes total internal reflection at the surface GVL2h and reaches the surface LUS. The light LT repeatedly reflects between the surface LUS and the surface LBS, and propagates in a direction opposite to the first direction X.

When the propagating light LT has entered the light-outputting structures UPR provided on the surface LBS, the light LT is reflected by the light-outputting structures UPR and is lifted upward. The upwardly lifted light LT exits from the light-emitting light guide LGP and enters the optical sheet OPSh. The light LT having entered the optical sheet OPSh is emitted upward along a direction parallel to the third direction Z by the protrusions provided on the optical sheet OPSh. Then, the light LT enters the display panel PNLh from the optical sheet OPSh.

In the illumination device ILDh shown in FIG. 6, the light LT having uniform luminance enters the optical sheet OPSh from the surface LUS, which is the upper surface of the light-emitting light guide LGEh. With this configuration, the light can be delivered to the display panel with low loss and at high efficiency.

In the example shown in FIG. 5, the display panel PNLh is disposed adjacent to the light guide LGMh, while interposing the optical sheet OPSh therebetween. In the example shown in FIG. 6, the display panel PNLh is disposed adjacent to the light guide LGEh while interposing the optical sheet OPSh therebetween.

With the above-described embodiment, it is possible to provide a head-mounted display with a display device that does not hit the user's nose.

### Embodiment 2

As compared to the configuration example presented in Embodiment 1, Embodiment 2 is different in that the lengths of optical paths of light emitted from the light source element are the same regardless of location. First, the issues addressed by Embodiment 1 will be described.

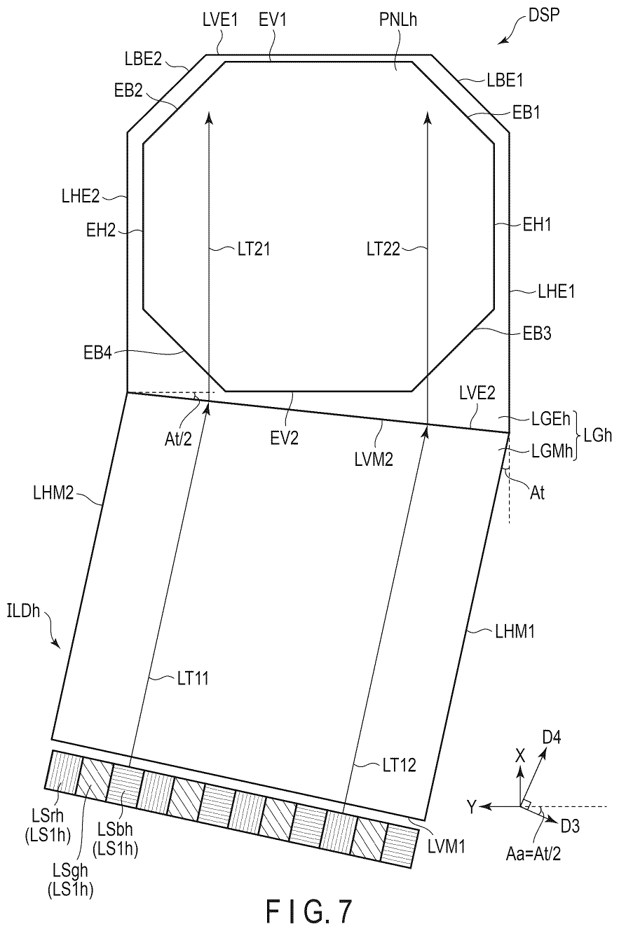

FIG. 7 is a plan view of the display device shown in FIG. 3 when unfolded. In the display device DSP shown in FIG. 7, the light guide LGEh and the light guide LGMh are folded back at the edge LVE2 and edge LVM2, respectively.

As shown in FIG. 3, the light guide LGMh is disposed obliquely relative to the light guide LGEh at a corner At. Light emitted from the light source element LS1h near the edge LHM2 is referred to as light LT11. Light emitted from the light source element LS1h near the edge LHM1 is referred to as light LT12.

The light LT11 and the light LT12 propagate along the direction in which the edges LHM2 and LHM1 extend (the direction D4) while repeating total internal reflection within the light guide LGMh. The light LT11 and the light LT12 having reached the edge LVM2 enter the inside of the light guide LGEh.

The light LT11 and the light LT12, having entered the light guide LGEh, propagate along the direction in which the edges LHE1 and LHE2 extend (that is, the first direction X) while repeating total internal reflection within the light guide LGEh as light LT21 and light LT22, respectively.

The light guide LGEh and the light guide LGMh are arranged obliquely, differences result in the length of optical paths of the light LT11 and light LT21, and in the length of optical paths of light LT12 and light LT22. The length of optical paths of light LT12 and light LT22 is greater than that of optical paths of light LT11 and light LT21, respectively.

Consequently, there is a risk that the light emitted from the light guide LGEh may not achieve uniform luminance. In Embodiment 2, by forming the edge LVM1 of the light guide LGMh into a stepped configuration, the lengths of optical paths of light emitted from the light source element LS1h is made constant regardless of the location of the light source element LS1h. With this configuration, it is possible to provide an illumination device which can emit light with uniform luminance.

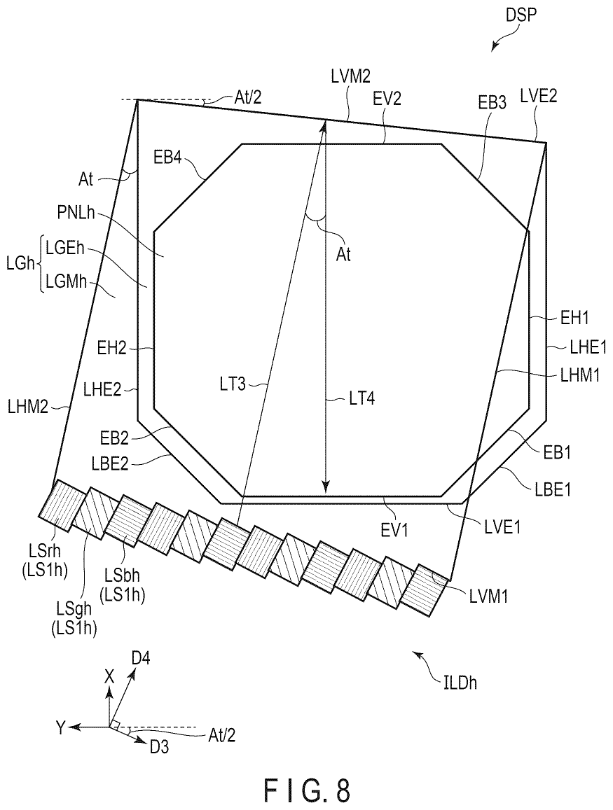

FIG. 8 is a plan view schematically showing an example of the configuration of the display device of Embodiment 2. The display device DSP shown in FIG. 8 is different from the display device DSP shown in FIG. 3 in that the edge LVM1 of the light guide LGMh is provided in a stepped configuration.

The light LT3 emitted from the light source element LS1h enters the inside of the light guide LGMh from the edge LVM1 of the light guide. The light LT3 having entered the inside of the light guide LGMh propagates along the direction D4 while repeating total internal reflection within the light guide LGMh.

The light LT3 having reached the edge LVM2 of the light guide LGMh enters the inside of the light guide LGEh from the edge LVE2 of the light guide LGEh. The light LT3 having entered the inside of the light guide LGEh propagates in a direction opposite to the first direction X while repeating total internal reflection within the light guide LGEh as light LT4.

The light LT4 having reached the protrusions (which may as well be referred to as prisms or grooves) provided on the light guide LGEh no longer satisfies the conditions for total internal reflection. The light LT4 that does not satisfy the conditions for total internal reflection exits the light guide LGEh and enters the display panel PNLh. In this manner, the display panel PNLh is illuminated.

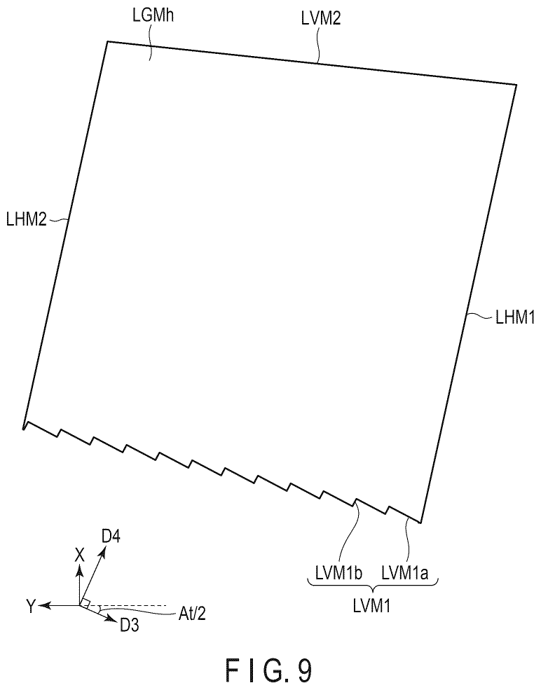

FIG. 9 is a plan view showing only the light guide LGMh of FIG. 8. The edge LVM1 of the light guide LGMh has an edge LVM1a and an edge LVM1b. The direction in which the edge LVM1a extends and the direction in which the edge LVM1b extends intersect each other perpendicularly, for example. But note here that the angle at which the direction of the edge LVM1a and the direction of the edge LVM1b intersect is not limited to perpendicular (90°), it may be a different angle.

The direction in which the edge LVM1b extends may, for example, be a direction inclined relative to the direction D4. The direction in which the edge LVM1a extends may, for example, be the direction D3.

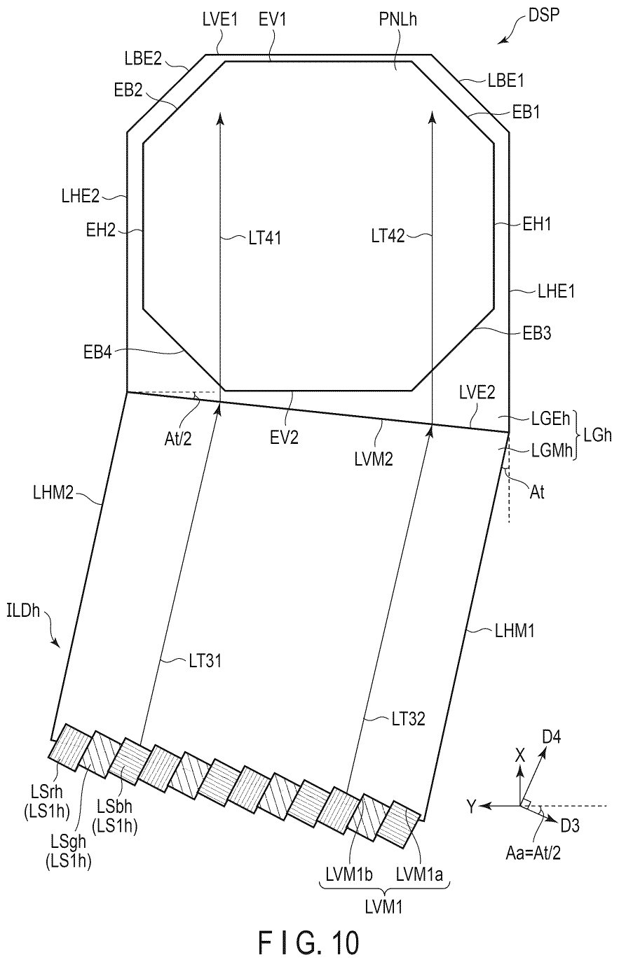

FIG. 10 is a plan view of the display device shown in FIG. 8 when unfolded. A plurality of light source elements LS1h are arranged to face the stepped edge LVM1 of the light guide LGMh. The light emitted from the light source element LS1h near the edge LHM2 is referred to as light LT31. The light emitted from the light source element LS1h near the edge LHM1 is referred to as light LT32.

The light LT31 and the light LT32 propagate along the direction in which the edges LHM2 and LHM1 extend (that is, the direction D4) while repeating total internal reflection inside the light guide LGMh. The light LT31 and the light LT32, having reached the edge LVM2, enters the inside of the light guide LGEh.

The light LT31 and the light LT32, having entered the inside of the light guide LGEh, propagate along the direction in which the edges LHE1 and LHE2 extend (that is, the first direction X) while repeating total internal reflection inside of the light guide LGEh as light LT41 and light LT42, respectively.

The length of optical paths of the light LT31 and light LT41 is the same as the length of optical paths of the light LT32 and light LT42, respectively. The disposition of the light source element LS1h, as well as the angles and lengths (pitch) of the edges LVM1a and LVM1b, are set such that these two optical path lengths are equal to each other. With this configuration, it is possible to realize an illumination device which can emit light with uniform luminance. With such an illumination device thus equipped, a display device which can display images with uniform luminance can be obtained.

In this disclosure, the light guide LGMh may as well be referred to as a first light guide, and the light guide LGEh may as well be referred to as a second light guide. The edges LVM1, LVM2, LHM1, and LHM2 of the light guide LGMh may as well be referred to as a first edge, a second edge, a third edge, and a fourth edge, respectively. The edges LVE1, LVE2, LHE1, and LHE2 of the light guide LGEh may as well be referred to as a fifth edge, a sixth edge, a seventh edge, and an eighth edge, respectively.

In this disclosure, the angle At may as well be referred to as a first angle, and the angle Aa may as well be referred to as a second angle. The second angle, angle Aa, is one-half (½) of the first angle, angle At. In other words, the first angle, angle At, is twice the second angle, angle Aa.

In this disclosure, the edges LBE1 and LBE2 of the light guide LGEh may as well be referred to as a ninth edge and a tenth edge, respectively. In this disclosure, the edges EV1, EV2, EH1, and EH2 of the display panel PNLh may as well be referred to as an eleventh edge, a twelfth edge, a thirteenth edge, and a fourteenth edge, respectively. The edges EB1, EB2, EB3, and EB4 of the display panel PNLh may as well be referred to as a fifteenth edge, a sixteenth edge, a seventeenth edge, and an eighteenth edge, respectively.

In FIGS. 8 to 10, the edges LVM1a and LVM1b of the edge LVM1 may as well be referred to as a first short edge and a second short edge, respectively.

In FIG. 10, the light source element LS1h near the edge LHM2 and the light source element LS1h near the edge LHM1 may as well be referred to as a first light source element and a second light source element, respectively. Alternatively, the light source element LS1h near the edge LHM2 and the light source element LS1h near the edge LHM1 may as well be referred to as a second light source element and a first light source element, respectively. Furthermore, one of a plurality of light source elements LS1 may as well be referred to as a first light source element, and another may be referred to as a second light source element.

In FIG. 10, the length of optical paths of the light LT31 and light LT41 may as well be referred to as first optical path length, and the length of optical paths of the light LT32 and light LT42 may as well be referred to as second optical path length.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is

1. A display device comprising:
a first light guide including a first edge, a second edge, a third edge, and a fourth edge;
a second light guide including a fifth edge, a sixth edge, a seventh edge, and an eighth edge;
a plurality of light source elements disposed to face the first edge of the first light guide; and
a display panel provided adjacent to the first light guide or the second light guide,
wherein
the second edge is disposed on a side opposite to the first edge and is non-parallel to the first edge,
the third edge and the fourth edge are each provided between the first edge and the second edge,
the sixth edge is disposed on a side opposite to the fifth edge and is non-parallel to the fifth edge,
the seventh edge and the eighth edge are each provided between the fifth edge and the sixth edge,
the second edge and the sixth edge overlap, and
the first light guide and the second light guide are disposed obliquely such that a direction of a main ray emitted from the light source element and propagating through the first light guide forms an acute angle with a direction of a main ray propagating through the second light guide.

2. The display device according to claim 1, wherein
the display panel has a polygonal shape.

3. The display device according to claim 1, wherein
the display panel has an octagonal shape.

4. The display device according to claim 1,
wherein
the acute angle is referred to as a first angle,
an angle formed between a direction in which the sixth edge extends and a direction perpendicular to the main ray propagating in the second light guide is referred to as a second angle, and
the second angle is one-half of the first angle.

5. The display device according to claim 3, wherein
the second light guide includes a ninth edge provided between the fifth edge and the seventh edge, and a tenth edge provided between the fifth edge and the eighth edge,
the display panel includes an eleventh edge and a twelfth edge parallel to the fifth edge, a thirteenth edge and a fourteenth edge parallel to the seventh edge and the eighth edge, a fifteenth edge and an eighteenth edge parallel to the ninth edge, and a sixteenth edge and a seventeenth edge parallel to the tenth edge, and
the eleventh edge, the twelfth edge, the thirteenth edge, the fourteenth edge, the fifteenth edge, the sixteenth edge, the seventeenth edge, and the eighteenth edge form the octagonal shape of the display panel.

6. A display device comprising:
a first light guide including a first edge, a second edge, a third edge, and a fourth edge;
a second light guide including a fifth edge, a sixth edge, a seventh edge, and an eighth edge;
a plurality of light source elements disposed to face the first edge of the first light guide;
a display panel provided adjacent to the first light guide or the second light guide,
wherein
the first edge includes a plurality of first short edges and a plurality of second short edges arranged in a step-like configuration,
the plurality of light source elements are disposed to face the plurality of first short edges, respectively,
the second edge is disposed on a side opposite to the first edge and is non-parallel to the first edge,
the third edge and the fourth edge are each provided between the first edge and the second edge,
the sixth edge is disposed on a side opposite to the fifth edge and is non-parallel to the fifth edge,
the seventh edge and the eighth edge are each provided between the fifth edge and the sixth edge,
the second edge and the sixth edge overlap and coincide with each other, and
the first light guide and the second light guide are disposed obliquely such that a direction of a main ray emitted from the light source element and propagating in the first light guide forms an acute angle with a direction of a main ray propagating through the second light guide.

7. The display device according to claim 6, wherein
the display panel has a polygonal shape.

8. The display device according to claim 6, wherein
the display panel has an octagonal shape.

9. The display device according to claim 6, wherein
the acute angle is referred to as a first angle,
an angle formed between a direction in which the sixth edge extends and a direction perpendicular to the main ray propagating through the second light guide is referred to as a second angle, and
the second angle is one-half of the first angle.

10. The display device according to claim 8, wherein
the second light guide includes a ninth edge provided between the fifth edge and the seventh edge, and a tenth edge provided between the fifth edge and the eighth edge,
the display panel includes an eleventh edge and a twelfth edge parallel to the fifth edge, a thirteenth edge and a fourteenth edge parallel to the seventh edge and the eighth edge, a fifteenth edge and an eighteenth edge parallel to the ninth edge, and a sixteenth edge and a seventeenth edge parallel to the tenth edge, and
the eleventh edge, the twelfth edge, the thirteenth edge, the fourteenth edge, the fifteenth edge, the sixteenth edge, the seventeenth edge, and the eighteenth edge form the octagonal shape of the display panel.

11. The display device according to claim 6, wherein
a length of an optical path for light emitted from a first light source element among the plurality of light source elements and propagating in the first light guide, and an optical path for light propagating through the second light guide, is referred to as a first optical path length,
a length of an optical path for light emitted from a second light source element, which is different from the first light source element, among the plurality of light source elements and propagating in the first light guide, and an optical path for light propagating in the second light guide, is referred to as a second optical path length, and
the first optical path length and the second optical path length are the same as each other.
